(19) United States
(12) Patent Application Publication
(10) Pub. No.: US 2011/0264627 A1
(43) Pub. Date: Oct. 27, 2011

(54) SYSTEM AND METHOD FOR PROVIDING AUTOMATIC UPDATE

(75) Inventors: Dong-Yul LEE, Gyeongsangbuk-do (KR); Hak-Sung LYOU, Gyeongsangbuk-do (KR)

(73) Assignee: SAMSUNG ELECTRONICS CO., LTD., Gyeonggi-Do (KR)

(21) Appl. No.: 13/091,260

(22) Filed: Apr. 21, 2011

(30) Foreign Application Priority Data
Apr. 21, 2010 (KR) 10-2010-0037095

(51) Int. Cl. G06F 17/30

(52) U.S. Cl. 707/626; 707/E17.005

(57) ABSTRACT

A system for providing an automatic update includes: a server for real-time managing an original object to which an original identifier is allocated, writing a revision of the original object by a Data Definition Language (DDL), allocating an identifier different from the original identifier to the revision of the original object, transmitting the identifier of the revision of the original object to a client if a request for an identifier of a predetermined object corresponding to the original object is received from the client, and providing the revision of the original object to the client through synchronization with the predetermined object in the client; and the client for requesting the server for the identifier of the predetermined object, checking an increase in the transmitted identifier by comparing the transmitted identifier with the identifier of the predetermined object in the client, and updating the predetermined object corresponding to the transmitted identifier through synchronization with the server according to a result of the comparison based on the revision of the original object corresponding to the transmitted identifier.

### CLAIM OF PRIORITY

This application claims priority under 35 U.S.C. §119 to an application entitled “System and Method for Providing Automatic Update” filed in the Korean Intellectual Property Office on Apr. 21, 2010 and assigned Serial No. 10-2010-0037095, the contents of which are incorporated herein by reference.

### BACKGROUND OF THE INVENTION

1. Field of the Invention

The present invention relates generally to a system and method for providing an automatic update, by which a continuous update of an object is automatically performed in a communication environment without any action of a user in a server/client environment.

2. Description of the Related Art

In an environment of various platforms, an update of already announced objects, such as software applications and development-related tools, occurs frequently.

When any of the objects is modified, a corresponding developer modifies a standard database by accessing a server computer using a development-related tool installed in a client computer or notifies users that the object has been modified, i.e., updated, through e-mailing. Then, since each of the users must perform processes, such as questions, answers, and approvals, with a server to individually update at least one object in a terminal of the user, the time for the update and its related questions/answers required of the user causes many inconveniences to the user.

Even though a live update function is implemented to clear this disadvantage, an additional application, such as a live update manager, must be developed, and a server corresponding to the additional application a must be operated, thus increasing costs in implementing the live update function. Further, a Data Definition Language (DDL) regarding object update execution must be programmed in a lump even when it is uncertain whether the update is performed, and therefore, there is a drawback in the object development.

### SUMMARY OF THE INVENTION

An object of the present invention is to substantially solve at least the above problems and/or disadvantages and to provide at least the advantages below. Accordingly, the present invention provides a system and method for providing an automatic update, by which the update is continuously performed through synchronization between a server and a client by allocating an identifier to only updated, i.e., modified, contents corresponding to an object for which the update is performed in a server/client environment.

According to one aspect of the present invention, there is provided a system for providing an automatic update, the system including: a server for real-time managing an original object to which an original identifier is allocated, writing a revision of the original object by a Data Definition Language (DDL), allocating an identifier different from the original identifier to the revision of the original object, transmitting the identifier of the revision of the original object to a client if a request for an identifier of a predetermined object corresponding to the original object is received from the client, and providing the revision of the original object to the client through synchronization with the predetermined object in the client; and the client for requesting the server for the identifier of the predetermined object, checking an increase in the transmitted identifier by comparing the transmitted identifier with the identifier of the predetermined object in the client, and updating the predetermined object corresponding to the transmitted identifier through synchronization with the server according to a result of the comparison based on the revision of the original object corresponding to the transmitted identifier.

According to another aspect of the present invention, there is provided a method of providing an automatic update, the method including: writing a revision of an original object, which are uploaded by a developer of the original object, by a Data Definition Language (DDL); allocating an identifier different from an original identifier, which is allocated to the original object, to the revision of the original object; transmitting the identifier of the revision of the original object to a client if a request for an identifier of a predetermined object corresponding to the original object is received from the client; and checking an increase in the transmitted identifier by comparing the transmitted identifier with the identifier of the predetermined object in the client and updating the predetermined object corresponding to the transmitted identifier through synchronization with a server according to a result of the comparison based on the revision of the original object corresponding to the transmitted identifier.

### BRIEF DESCRIPTION OF THE DRAWINGS

The above features and advantages of the present invention will become more apparent from the following detailed description when taken in conjunction with the accompanying drawing in which:

FIG. 1 is a general configuration of a system for providing an automatic update according to a preferred embodiment of the present invention;

FIG. 2 illustrates a Software Configuration Management (SCM) system for a platform development environment of an object developer in the system for providing an automatic update according to a preferred embodiment of the present invention; and

FIG. 3 is a flowchart of a method of providing an automatic update according to a preferred embodiment of the present invention.

### DETAILED DESCRIPTION OF THE INVENTION

Hereinafter, embodiments of the present invention will be described herein below with reference to the accompanying drawings. In the following description, although many specific items are shown, they are only provided to help general understanding of the present invention, and it will be understood by those of ordinary skill in the art that these specific items can be modified or changed within the scope of the present invention.

The present invention proposes a real-time updating of a plurality of objects through a Software Configuration Management (SCM) system without a request from a user or user manipulation, thereby eliminating a conventional object update method of relying on a direct manual operation of a user, such as a query, a response, or an approval associated with an update, which is individually performed for each object during a maintenance update of the plurality of objects provided to a plurality of clients through a server. This is achieved by an information provider in an information content routing network environment including the server, the information provider, and a client.

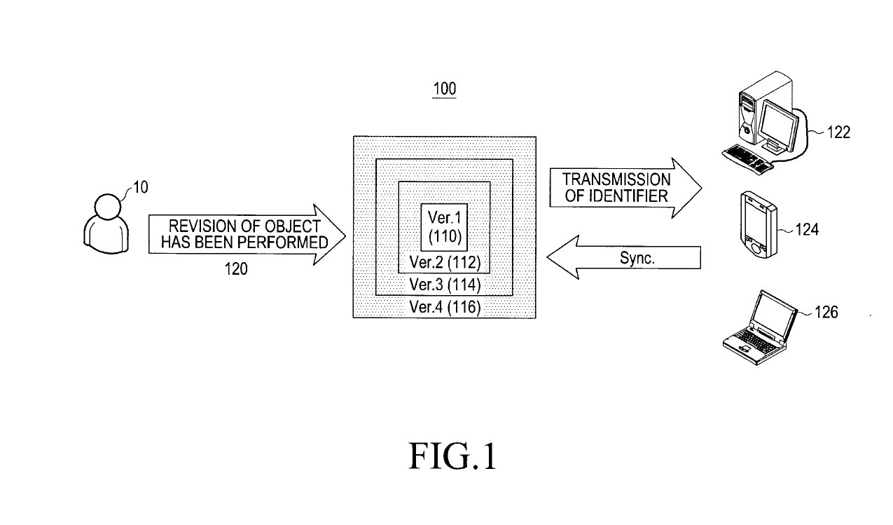

A system for providing an automatic update according to a preferred embodiment of the present invention will now be described in detail with reference to FIG. 1.

FIG. 1 is a general configuration of a system 100 for providing an automatic update according to a preferred embodiment of the present invention. Referring to FIG. 1, the system 100 includes a developer 10 developing a specific object, an object 110 (original object) developed by the developer 10 to perform a specific function, a server 120 for real-time managing the object 110 and providing the original object 110 to a plurality of clients 122, 124, and 126, who are receiving parties of the object 110 from the server 120. Note that the original object comprises a software application, a file, a directory, and a development tool for which a separate syntax related to a live update is not defined.

In more detail, the developer 10 registers the original object 110, i.e., web pages, a software application, a file, a directory, a development tool, or other data expressions, to the server 120 so that not only the developer 10 but also a plurality of users can use the original object 110.

In addition, when a revision of the original object 110 developed by the developer 10 is performed, that is, when an update for maintenance is performed, the developer 10 uploads the revision of the original object to the server 120 that is based on an initially developed object, i.e., the original object 110.

At this time, since a Data Definition Language (DDL) associated with a live update is not defined for the original object 110, the original object 110 is an object for which a table related to an update does not exist and an original identifier is allocated to the original object 110 initially developed by the developer 10. That is, after allocating an original identifier developed by the developer 10 to the original object 110, the server 120 writes the revision by a DDL, and allocates an identifier different from the original identifier to the revision of the original object 110 when updating the original object. Based on the above, the update regarding an added revision is started, so the DDL associated with the live update is not defined in the original object. Note that a subsequent identifier indicative of update will be incremented, for example, by one so that each identifier indicative of a number of updates performed for the original object.

The server 120 real-time manages the original object 110 to which the original identifier is allocated, writes the revision of the original object 110 via a Data Definition Language (DDL), allocates or assigns a new identifier different from the original identifier to the revision of the original object 110, transmits the new identifier of the revision of the original object 110 to the clients 122, 124, and 126 when a query on the original identifier of the original object 110 is received from the clients 122, 124, and 126. That is, the original identifier is allocated to the original object 110 initially developed by the developer 10. Then, the server 120 writes the revision by the DDL, allocates an identifier different from the original identifier to the revision of the original object 110, and provides the revision to the clients through synchronization with a corresponding object in the clients when updating the original object. Thereafter, the revision of the original object 110 is provided to the clients 122, 124, and 126 through synchronization with a corresponding object in the clients 122, 124, and 126.

In other words, the server 120 writes an added revision of the original object 110 in a database (not shown) or a specific repository (not shown) of the server 120 based on the original object 110 uploaded by the developer 10 via a DDL in a format of a table or a text file, then allocates an identifier different from the original identifier so that the revision of the original object 110 can be discriminated from the original object 110. For example, the server 120 controls that the identifier allocated to the revision of the original object 110 is counted in an ascending order and allocated based on the original identifier of the original object 110 whenever a revision is performed for the original object 110. For convenience of description, the identifier allocated to the revision of the original object 110 is named as a version 1 110, a version 2 112, a version 3 114, a version 4 116 and so forth. Thus, as an identifier allocated to a predetermined object corresponds to an increased identifier based on an original identifier of an original object corresponding to the predetermined object, the identifier indicates that a number of updates have been performed for the original object. Accordingly, the identifier different from the original identifier of the original object 110 defines a latest information update of the original object 110 to which the original identifier is allocated.

Each of the plurality of clients 122, 124, and 126 requests the server 120 for an identifier of a predetermined object corresponding to the original object 110, checks an increase in the transmitted identifier by comparing the transmitted identifier with the identifier of the predetermined object in the client 122, 124, or 126, determines that a revision of the predetermined object is made when the transmitted identifier is increased from the identifier of the predetermined object in the client 122, 124, or 126, and then updates the predetermined object through synchronization with the server 120 based on the revision of the original object 110 corresponding to the transmitted identifier.

Thereafter, each of the plurality of clients 122, 124, and 126 changes the identifier of the predetermined object for which an update has been performed through synchronization with the server 120 to the identifier transmitted from the server 120.

As a result of the comparison to check an increase in the identifier transmitted from the server, if the transmitted identifier is not increased from the predetermined object in the client 122, 124, or 126, which corresponds to the transmitted identifier, that is, if the transmitted identifier is equal to or less than the identifier of the predetermined object in the client 122, 124, or 126, which corresponds to the transmitted identifier, the client 122, 124, or 126 perceives that a revision of the predetermined object has not been performed and does not perform an update of the predetermined object.

As described above, the identifier transmitted from the server 120 as a response responding to a request of the client 122, 124, or 126 may be the original identifier allocated to the original object 110 or an identifier most lately allocated based on the original object 110. That is, the present invention provides a method for providing an automatic update in a server/client environment. Based on the original objects, an automatic update, by which the update is continuously performed through synchronization between a server and a client by allocating an identifier to only updated. To solve the problem that a prior developer must be programmed in a lump even when it is uncertain whether the update is performed, the present invention incorporates a feature of continually receiving the corresponding identifier in the client executing the objects, and performing the update regarding only the revision through a comparing outcome.

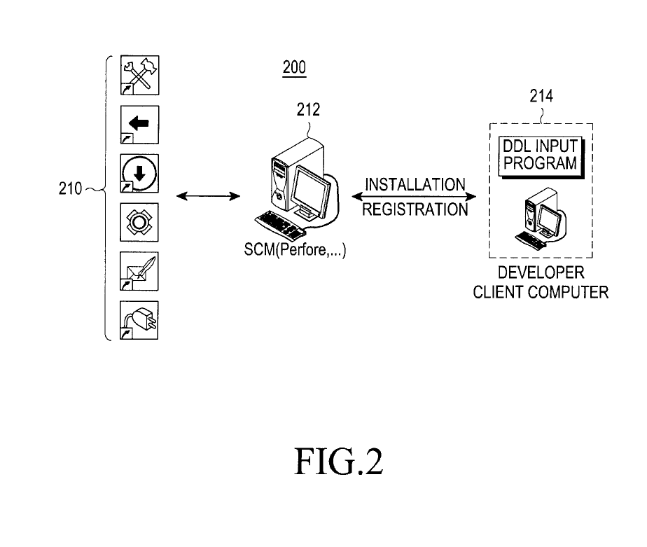

FIG. 2 illustrates a Software Configuration Management (SCM) system 200 for a platform development environment for an object developer of the system 100 for providing an automatic update according to a preferred embodiment of the present invention. Referring to FIG. 2, a plurality of development-related tools 210 needed for object developers to develop tools associated with the system 100 are registered in an SCM server 212 and used by a plurality of developers.

That is, tools needed to develop a predetermined object among the plurality of development-related tools 210 registered in the SCM server 212 by a developer are used by the developer and a plurality of developers by being installed a developer client computer 214 to develop the predetermined object. If an update is performed for one of the plurality of development-related tools 210, a revision thereof is written in an update table (not shown) or an update repository (not shown) of the SCM server 212 using a DDL input program in the developer client computer 214 of the developer. Here, a script represented by a DDL is actually written, and if a revision of any of the plurality of development-related tools 210 is performed, that is, if an update for maintenance is performed. Here, the developer who can perform addition, modification, and deletion of elements of an object uploads the revision to the SCM server 212 based on an initially developed original tool.

In this case, since a DDL associated with a live update is not defined for the original tool, a table related to an update is a non-existing tool, and an original identifier is allocated to the original tool initially developed by the developer.

The SCM server 212 real-time manages the original tool to which the original identifier is allocated, writes a revision of the original tool by a DDL, allocates an identifier different from the original identifier to the revision of the original tool, transmits the identifier of the revision of the original tool to the developer client computer 214 if a request (or query) of an identifier of a predetermined tool corresponding to the original tool is received from the developer client computer 214, and then provides the revision of the original tool to the developer client computer 214 through synchronization with the predetermined tool in the developer client computer 214.

The developer client computer 214 requests the SCM server 212 for the identifier of the predetermined tool, checks an increase in the transmitted identifier by comparing the transmitted identifier with the identifier of the predetermined tool in the developer client computer 214, and updates the predetermined tool corresponding to the transmitted identifier through synchronization with the SCM server 212 according to a result of the comparison based on the revision of the original tool corresponding to the transmitted identifier.

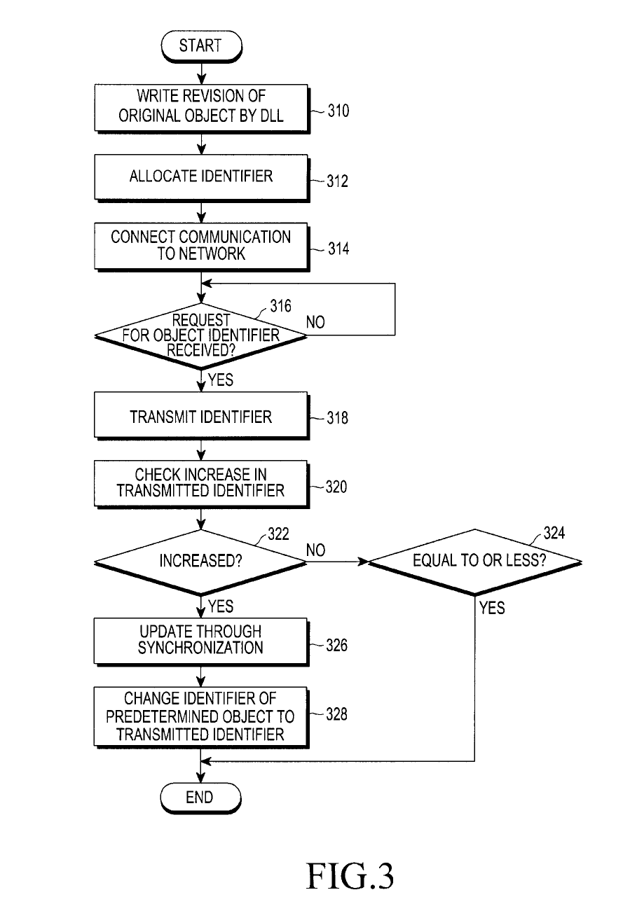

FIG. 3 is a flowchart of a method of providing an automatic update according to a preferred embodiment of the present invention. Referring to FIG. 3, in step 310, a revision of an object is written by a DDL. That is, when a revision of a predetermined one of a plurality of objects uploaded and managed by a developer is performed, if a revision based on an initially developed object, i.e., an original object, is uploaded to a server, the server matches the revision to the object corresponding to the original object and writes the revision by the DDL.

In step 312, an identifier different from the original identifier allocated to the initially developed original object is allocated to the revision of the object.

The identifier different from the original identifier is counted in an ascending order, e.g., in an order of ver.1, ver.2, ver.3 and so forth, and allocated based on the original identifier allocated to the original object whenever a revision of the object is performed. Thus, as an identifier allocated to a predetermined object corresponds to an increased identifier based on an original identifier of an original object corresponding to the predetermined object, the identifier indicates that a number of updates have been performed for the original object. Accordingly, the identifier different from the original identifier of the original object defines a latest information update of the original object to which the original identifier is allocated.

If communication between the server and a client starts through a network in step 314, the server checks in step 316 whether a request is received from the client.

The request received from the client is related to an identifier of a predetermined object corresponding to the original object, and as a result of the check, the server transmits the identifier of the object corresponding to the original object to the client in response to the request in step 318.

In step 320, if the identifier of the object is transmitted from the server, the client checks an increase in the transmitted identifier by comparing the transmitted identifier with the identifier of the predetermined object.

If the transmitted identifier is increased as a result of the comparison in step 322, the client updates the predetermined object corresponding to the transmitted identifier through synchronization with the server based on the revision of the original object corresponding to the transmitted identifier in step 326.

In step 328, the client changes the identifier of the predetermined object for which an update has been performed through the synchronization with the server to the transmitted identifier.

If the transmitted identifier is not increased from the identifier of the predetermined object in the client as a result of the comparison in step 322, and if the client the transmitted identifier is equal to or less than the identifier of the predetermined object in the client in step 324, the client perceives that a revision of the predetermined object has not been performed and ends the process without performing an update of the predetermined object.

According to the present invention, when an update is performed for an object individually existing in a plurality of clients, by allocating a separate identifier to a revision of the object and transmitting the separate identifier, a developer does not have to define a separate syntax associated with a live update when the object is initially developed, and a client having a plurality of objects may simply perceive through an identifier whether a predetermined object has been updated.

Since an update is automatically performed according to an increase in the identifier when communication between a server and the client starts, an update of the entire objects is generally performed without relying on a manual operation of a user.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a controller that may be a general purpose computer, a special processor, a programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for providing an automatic update, comprising:
a server for real-time managing an original object to which an original identifier is allocated, writing a revision of the original object by a Data Definition Language (DDL), allocating an identifier different from an original identifier to the revision of the original object, transmitting the identifier of the revision of the original object to a client if a request for an identifier of a predetermined object corresponding to the original object is received from the client, and providing the revision of the original object to the client through synchronization with the predetermined object in the client; and
the client for checking an increase in the transmitted identifier number by comparing the transmitted identifier with the identifier of the predetermined object in the client, and updating the predetermined object corresponding to the transmitted identifier through synchronization with the server based on the comparison outcome.

2. The system of claim 1, wherein the client changes the identifier of the predetermined object for which an update has been performed to the identifier transmitted from the server.

3. The system of claim 1, wherein the transmitted identifier is the original identifier allocated to the original object or an identifier most lately allocated based on the original object.

4. The system of claim 1, wherein the original object comprises a software application, a file, a directory, and a development tool for which a separate syntax related to a live update is not defined.

5. The system of claim 1, wherein the DDL is written in a database or a predetermined repository.

6. The system of claim 1, wherein the allocation of the identifier is counted in an ascending order based on the original identifier of the original object whenever a revision of the original object is performed.

7. The system of claim 1, wherein the DDL is in a format of a table or a text file.

8. The system of claim 1, wherein the identifier different form the original identifier defines a latest information update of the original object to which the original identifier is allocated.

9. The system of claim 1, wherein the revision of the original object is uploaded to the server by a developer of the original object.

10. A method of providing an automatic update, the method comprising:
writing a revision of an original object, which are uploaded by a developer of the original object, via a Data Definition Language (DDL);
allocating an identifier different from an original identifier of the original object to the revision of the original object;
transmitting the identifier of the revision of the original object to a client if a request for an identifier of a predetermined object corresponding to the original object is received from the client; and
checking an increase in the transmitted identifier by comparing the transmitted identifier with the identifier of the predetermined object in the client and updating the predetermined object corresponding to the transmitted identifier through synchronization with a server according to the comparison outcome.

11. The method of claim 10, further comprising changing the identifier of the predetermined object for which an update has been performed in the client to the identifier transmitted from the server.

12. The method of claim 10, wherein the transmitted identifier is the original identifier allocated to the original object or an identifier most lately allocated based on the original object.

13. The method of claim 10, wherein the identifier different form the original identifier defines a latest information update of the original object to which the original identifier is allocated.

14. The method of claim 10, wherein the allocation of the identifier is counted in an ascending order based on the original identifier of the original object whenever a revision of the original object is performed.
